(19) United States
(12) Patent Application Publication
(10) Pub. No.: US 2025/0337803 A1
(43) Pub. Date: Oct. 30, 2025

(54) System and Method for Intelligent Adaptive Bitrate (ABR) Streaming

(71) Applicant: DISH Network Technologies India Private Limited, Bengaluru, Karnataka (IN)

(72) Inventor: Shreyansh Divya, Bengaluru (IN)

(21) Appl. No.: 18/644,566

(22) Filed: Apr. 24, 2024

(51) Int. Cl. H04L 65/75

(52) U.S. Cl. CPC H04L 65/75; H04L 65/752; H04L 65/756

(57) ABSTRACT

Systems, devices, and methods related to media streaming are provided. An example media streaming system includes a media server connected to a network and a bitrate controller connected to the network. The media server is configured to transmit a media stream to a client device connected to the network in a sequence of successive time periods along a chronological timeline. The bitrate controller is configured to continuously monitor the network and obtain real-time network performance data indicating a current status of the network for each time period, obtain real-time operating status data indicating a current operating status of the client device for each time period, determine a bitrate for each time period, based on the network performance data and the operating status data, and cause the media server to transmit the media stream to the client device at the determined bitrate for each time period.

### BACKGROUND

Traditional adaptive bitrate streaming (ABR) technologies have been widely utilized to deliver video content over the internet, catering to varying network conditions and device capabilities. In a conventional ABR system, video content is pre-encoded at multiple fixed bitrates, and the client device selects the appropriate bitrate based on available network bandwidth and buffer occupancy. However, conventional ABR approaches often face challenges in providing a seamless viewing experience under fluctuating network conditions. Buffering, pauses, and drops in video quality are common occurrences, particularly in situations where network bandwidth is limited or unstable. These limitations stem from the reliance on simplistic algorithms that may not fully capture the complex dynamics of network variability and user preferences. As a result, there is a need for a more intelligent and adaptive approach to bitrate streaming that can dynamically adjust to real-time network conditions while optimizing the viewing experience for users across diverse environments.

### SUMMARY

In accordance with some embodiments of the present disclosure, a method is provided. The method may be a computer-implemented method. In one example, a method for transmitting a media stream from a media server to a client device via a network in a sequence of successive time periods along a chronological timeline is provided. The method includes continuously monitoring the network by a bitrate controller connected to the network and obtaining real-time network performance data indicating a current status of the network for each time period, obtaining, by the bitrate controller, real-time operating status data indicating a current operating status of the client device for each time period, determining, by the bitrate controller, a bitrate for each time period, based on the network performance data and the operating status data, and transmitting, by the media server, the media stream to the client device at the determined bitrate for each time period. In some embodiments, the bitrate is determined using an artificial intelligence or machine learning (AI/ML) model.

In accordance with some embodiments of the present disclosure, a media streaming system is provided. In one example, the media streaming system includes a media server and a streaming controller, both connected to the communications network. The streaming controller is configured to continuously monitor streaming environment and obtain real-time streaming environment data, continuously track operating status of a client device and obtain real-time operating status data of the client device, determine an optimal value of one or more streaming parameters using an AI/ML model, and cause the media server to adjust the one or more streaming parameters based on the optimal value.

In another example, a media streaming system includes a media server connected to a network and a bitrate controller connected to the network. The media server is configured to transmit a media stream to a client device connected to the network in a sequence of successive time periods along a chronological timeline. The bitrate controller is configured to continuously monitor the network and obtain real-time network performance data indicating a current status of the network for each time period, obtain real-time operating status data indicating a current operating status of the client device for each time period, determine a bitrate for each time period, based on the network performance data and the operating status data, and cause the media server to transmit the media stream to the client device at the determined bitrate for each time period.

In accordance with some embodiments of the present disclosure, a computer device or computer system is provided. In one example, the computer device or computer system includes: one or more processors and a computer-readable storage media storing computer-executable instructions. The computer-executable instructions, when executed by the one or more processors, cause the computer device or computer system to perform a method described in the present disclosure.

In accordance with some embodiments, the present disclosure also provides a non-transitory machine-readable storage medium encoded with instructions, the instructions executable to cause one or more electronic processors of a computer system or computer device to perform any one of the methods described in the present disclosure.

### BRIEF DESCRIPTION OF THE DRAWINGS

FIG. 1 is a block diagram illustrating an example of a media streaming system, according to various embodiments of the present disclosure.

FIG. 2 is a block diagram illustrating another example of a media streaming system, according to various embodiments of the present disclosure.

FIG. 3A is a diagram illustrating an example of a neural network that has been trained to determine streaming parameters, according to various embodiments of the present disclosure.

FIG. 3B is a diagram illustrating an example of a neuron in FIG. 3B, according to various embodiments of the present disclosure.

FIGS. 4-5 are a flow diagrams respectively illustrating example methods for media streaming, according to various embodiments of the present disclosure.

FIG. 6 is a flow diagram illustrating a process for training artificial intelligence/machine learning (AI/ML) model(s), according to an embodiment of the present disclosure.

FIG. 7 illustrates an example computer system or computer device, according to various embodiments of the present disclosure.

### DETAILED DESCRIPTION

The present disclosure provides systems, devices, and methods generally related to media streaming, and more particularly to adaptive bitrate streaming (ABR).

In a conventional ABR system, the media server typically segments media content into chunks of varying durations and encode each chunk at multiple bitrates (e.g., low, medium, high). The network bandwidth and buffer occupancy are monitored to make bitrate adaptation adjustments. When network conditions deteriorate beyond predefined thresholds, such as buffer fullness or available bandwidth, the client device may be instructed to switch to a lower bitrate to prevent buffering, sacrificing video quality in the process. On the other hand, when network conditions improve beyond these thresholds, the client device may be instructed to switch to a higher bitrate to enhance video quality. However, these bitrate adaptation decisions are often discrete and threshold-based. For example, media content is typically encoded at multiple fixed bitrates, such as low (e.g., 500 kbps), medium (e.g., 1,500 kbps), and high (e.g., 3,000 kbps) levels. Initially, a client device selects an initial bitrate based on the available bandwidth (e.g., 3,000 kbps). Typically, the media server has predefined thresholds for bandwidth. If the measured bandwidth drops below a certain threshold, such as 1,000 kbps, due to network congestion, the media server switches to the low bitrate of 500 kbps. Conversely, if network conditions improve and the available bandwidth exceeds the threshold (e.g., 5,000 kbps, the client may increase the bitrate, for example, switching to the high bitrate of 3,000 kbps to enhance video quality.

However, the threshold-based ABR approach described faces several challenges that can impact the streaming experience. The threshold-based ABR approach often sets predefined thresholds for network metrics such as bandwidth. However, network conditions can fluctuate rapidly, and these predefined thresholds may not always accurately capture the dynamic nature of network variability. As a result, the threshold-based ABR may not respond quickly enough to sudden drops or spikes in available bandwidth, thus suboptimal bitrate selections and potential buffering or interruptions in playback can occur. Additionally, the threshold-based ABR relies on discrete and rigid threshold values to trigger bitrate changes, but it may not fully optimize video quality and bandwidth efficiency and may fail to adapt bitrate selections dynamically to achieve an optimal balance between video quality and bandwidth utilization.

The present disclosure provides techniques and solutions to addressing the above-mentioned challenges. One insight provided in the present disclosure is related to the implementation of a streaming controller on a centralized server. The centralized control enables uniform management of the streaming process to allow for a consistent viewing experience for users across different client devices. Additionally, by leveraging server-side algorithms, bitrate selection can be optimized in response to network conditions and operating status of the client device in a real-time, dynamic, and continuous manner. This dynamic approach enhances bandwidth efficiency, leading to better utilization of network resources, as compared to the traditional threshold-based ABR approaches with fixed bitrate levels. Moreover, the adoption of server-side adaptation may also simplify the logic required on client devices and eliminates the need for complex bitrate selection algorithms. As a result, client-side processing is minimized, and the performance of devices is improved with limited processing capabilities.

Another insight provided in the present disclosure is related to the development and utilization of AI/ML models for optimization streaming parameters. For example, AI/ML models can be trained, validated using historical network performance data and operating status data specific to the client device. The AI/ML models can be used by the streaming controller to determine optimal bitrates of the streamed content in real-time.

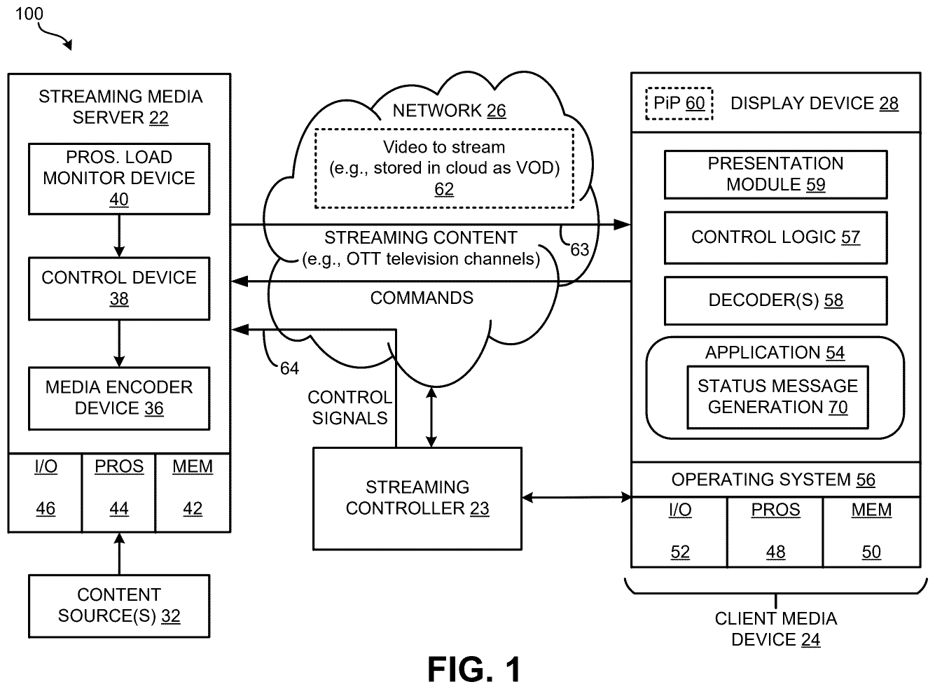

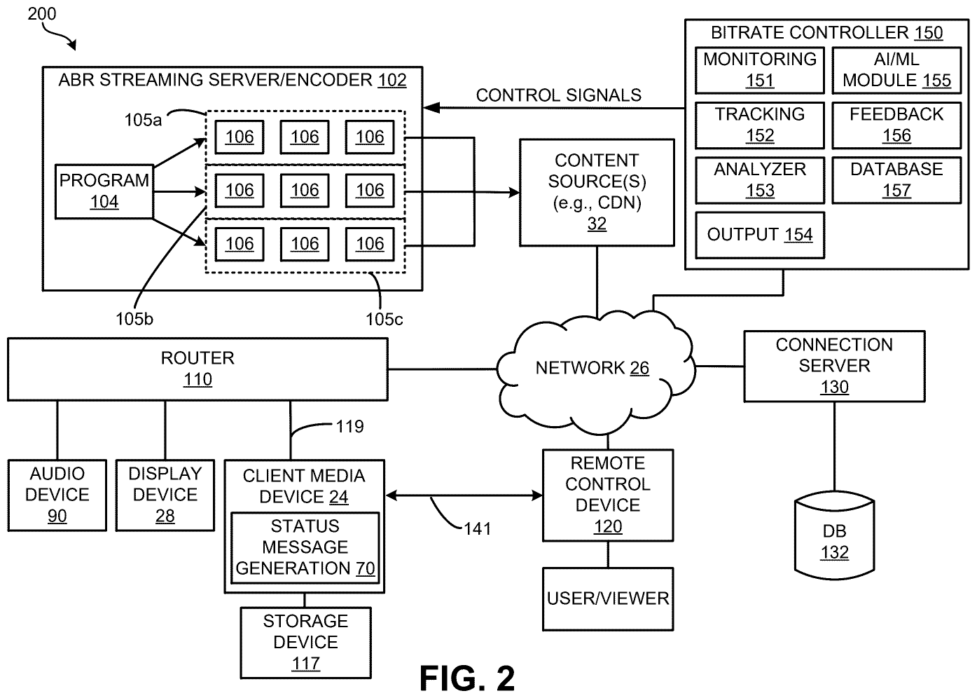

FIG. 1 schematically illustrates an example media streaming system 100, according to various embodiments of the present disclosure. In the illustrated example, the media streaming system 100 includes, among other components, a streaming media server 22 (or media server 22), a streaming controller 23, and a client media device 24 (or client device 24). In addition to media server 22 and client device 24, media streaming system 100 further includes a communications network 26 over which streaming video sessions are conducted. At a high level, the media server 22 is suitable for applying adaptive bit rate (ABR) during a streaming video session established between the media server 22 and at least one client device 24 via the communications network 26. The streaming controller 23 is responsible for monitoring the real-time streaming environment such as the network conditions of the communications network 26, the capability and a current status of the client device 24 or the media player application executed thereon, the user viewing preference on the streaming, optimize streaming parameters such as the bitrate based on the streaming environment data, and transmitting control signals to the media server 22 to cause the media server 22 to adjust the streaming parameters such as the bitrate of ABR streaming. An example of the streaming controller 23 is a bitrate controller 150 as depicted in FIG. 2, which will be described with details later.

It should be noted that each one of the components of media streaming system 100 may be independently a hardware component, a software component, or a combination of both. For example, the streaming controller 23 may operate as a separate device, independent from both the media server 22 and the client device 24. In this configuration, the streaming controller 23 could be a standalone hardware device or a cloud-based service responsible for monitoring and optimizing streaming parameters across multiple streaming sessions and client devices. Alternatively, the streaming controller 23 could be integrated as a component directly into the media server 22 and/or the client device 24. The integration could be in a form of a hardware module or a software package embedded within the existing infrastructure of the streaming server or client device. In some embodiments, the streaming controller 23 may also be implemented as a software package, application, or service that is deployable and executable on the client device 24. This allows for decentralized control, where each client device 24 is responsible for monitoring and optimizing its own streaming parameters based on local streaming environment and user preferences.

As depicted in FIG. 1, media server 22 and, more broadly, media streaming system 100 is provided as a generalized example and should not be construed as limiting in any respect. Communications network 26 may encompass any number of digital or other networks enabling bidirectional signal communication between the media server 22 and client device 24 utilizing common protocols and signaling schemes. In this regard, communications network 26 can include one or more open content delivery networks (CDNs), Virtual Private Networks (VPNs), Local Area Networks (LANs), Wide Area Networks (WANs), the Internet, and various other communications networks implemented in accordance with TCP/IP protocol architectures, User Datagram Protocol (UPD) architectures, or other communication protocols. In some embodiments, communications network 26 may also encompass a cellular network and/or any other public or private networks.

During a given streaming video session, the media server 22 encodes, packetizes, and transmits streaming video content over communications network 26 to client device 24. The streaming video content will typically, but need not necessarily include accompanying audio content. As the content is received, client device 24 decrypts (if needed) and decodes the streaming video content (also referred to as a “video stream,” a “video-containing media stream”, or a “media stream” herein). Client device 24 utilizes the newly-decoded content to generate corresponding video output signals, which are supplied to display device 28 for viewing by the client device 24. The video output signals may be transmitted within a single electronic device or system when client device 24 and display device 28 are combined as a unitary device, such as a smartphone, laptop computer, tablet computer, wearable device, or smart television (that is, a television containing an integrated media receiver). In other embodiments in which display device 28 is realized as an independent electronic device separate and apart from client device 24, such as a freestanding television set or monitor, client device 24 may output the video output signals as wired or wireless transmission, which is then forwarded to display device 28.

In some embodiments, media server 22 may encode, packetize, and transmit a single video stream during the streaming video session. In other instances, and as indicated in FIG. 1, media server 22 may concurrently transmit multiple video-containing media streams as, for example, a streaming channel bundle provided pursuant to an Over-the-Top (OTT) television service. In still other embodiments, media server 22 may concurrently provide separate video streams to multiple client devices 24; for example, as may occur when the media server 22 assumes the form of a consumer placeshifting device, which provides streaming content to multiple client devices (e.g., smartphones, tablets, televisions, or the like) located within a user's residence or similar area. Regardless of the number of streaming channels or video streams provided by the media server 22 to client device 24 during a given streaming video session, the streaming video content can be obtained from any number and type of content sources 32 in communication with or included within media server 22. Content sources 32 can include, for example, content providers and aggregators external to media server 22 and in communication with the media server 22 over communications network 26. In some embodiments, content sources 32 can include any number and type of storage mediums accessible to media server 22 (e.g., contained within or operably coupled to the media server 22) in which the video content subject to streaming is stored.

As appearing herein, the term “media server” is defined broadly to encompass any device or group of operably-interconnected devices capable of encoding video content at an ABR value, which is repeatedly adjusted in response to variations in processor load (and other factors) in the manner described herein. In the illustrated embodiment, media server 22 includes at least one media encoder device 36, which operates under the command of at least one control device 38. Additionally, media server 22 also includes a processor load monitoring device 40. While generically illustrated as a separate device in FIG. 1, the processor load monitoring device 40 can be combined with the control device 38 in some embodiments. Devices 36, 38, 40 can be implemented utilizing any combination of hardware and software (including firmware) components. For example, devices 36, 38, 40 may be implemented utilizing software or firmware embodied by code or computer-readable instructions residing within memory 42 and executed by at least one processor 44 (e.g., a CPU) further included in the media server 22. As illustrated, memory 42 generally depicts the various storage areas or mediums (computer-readable storage mediums) contained in media server 22 and may encompass any number and type of discrete memory sectors. In some embodiments, processor 44 may be a microprocessor, which is realized along with other non-illustrated components included in the media server 22 as a system-on-a-chip. Finally, it will be appreciated that media server 22 may contain various other components known in the art including, for example, any number and type of Input/Output (I/O) feature 46 enabling bidirectional communication with client device 24 and, perhaps, other nodes or devices over the communications network 26.

In accordance with other embodiments of the present disclosure, client device 24 can assume various different forms, including, but not limited, to that of a mobile phone, a wearable device, a tablet, a laptop computer, a desktop computer, a gaming console, a digital video recorder (DVR), or a set up box (STB). When engaged in a video streaming session with media server 22, client device 24 generates video signals for presentation on a display device 28. As indicated above, the display device 28 can be integrated into client device 24 as a unitary system or electronic device. This may be the case when client device 24 assumes the form of a mobile phone, tablet, laptop computer, a smart television, or similar electronic device having a dedicated display screen. In one embodiment, the display device 28 can assume the form of an independent device, such as a freestanding monitor or television set, which is connected to client device 24, such as a gaming console, DVR, STB, or another peripheral device, utilizing a wired or wireless connection. In such embodiments, the video output signals may be formatted in accordance with conventionally known standards, such as S-video, High Definition Multimedia Interface (“HDMI”), Sony/Philips Display Interface Format (“SPDIF”), Digital Video Interface (“DVI”), or Institute of Electrical and Electronics Engineers (IEEE) 1394 standards.

By way of non-limiting illustration, client device 24 is shown as including at least one processor 48 configured to selectively execute software instructions, in conjunction with associated memory 50 and I/O features 52. I/O features 52 can include a network interface, an interface to mass storage, an interface to display device 28, and/or various types of user input interfaces. Client device 24 may execute a software program or application 54 directing the hardware features of client device 24 to perform the functions described herein. Application 54 suitably interfaces with processor 48, memory 50, and I/O features 52 via any conventional operating system 56 to provide such functionalities. The software application can include a placeshifting application in embodiments where media server 22 assumes the form of an STB, DVR, or similar electronic device having placeshifting capabilities and typically located within a user's residence. In some embodiments, client device 24 may be implemented with special-purpose hardware or software, such as the SLINGBOX-brand products from Sling Media L.L.C., currently headquartered in Foster City, Calif., or the Hopper 3 brand product available from DISH Technologies L.L.C., or the AIRTV available from AirTV L.L.C. in Englewood, CO, and/or any other products.

With continued reference to FIG. 1, application 54 suitably includes control logic 57 adapted to process user input, receive streaming content 63 of the video stream from media server 22, decode the received streaming content, and provide corresponding output signals to display device 28 in the above-described manner. Application 54 decodes the streaming content of video stream utilizing at least one decoder 58, which may be implemented as specialized hardware or software executing on processor 48 in some embodiments. The decoded content is supplied to presentation device 59, which generates corresponding output signals transmitted to display device 28. In some embodiments, presentation device 59 may also combine decoded programming to create a blended or composite image, for example, one or more picture-in-picture (PIP) images 60 may be superimposed over a primary image generated on display device 28.

In operation, control logic 57 of client device 24 obtains programming in response to end user input received at I/O features 52 of the client device 24. Control logic 57 may establish a control connection with the media server 22 via communications network 26 enabling the transmission of commands from the control logic 57 to the control device 38. Media server 22 may operate by responding to commands received from a client device 24 via the communications network 26, as illustrated in FIG. 1 by control commands 64. Such commands may include information utilized to initiate a streaming video session, such as a placeshifting or OTT television session, with the media server 22 possibly including data supporting mutual authentication of the media server 22 and the client device 24. When the media server 22 assumes the form of a consumer placeshifting device, such as a STB or DVR located in a user's residence, control commands 64 may include instructions to remotely operate the placeshifting device, including to initiate and to change channels during an OTT session. Such commands may also be received at the client device 24 and forwarded to the media server 22, as appropriate, as a user navigates and otherwise interacts with the GUI of the streaming media interface application 54 executing on the client device 24.

Upon user request for initiation of a streaming video session, the streaming controller 23 determines an appropriate ABR value or setting at which to request a variant stream of the user-selected video stream to be received at the client device 24 and presented on the display device 28. The streaming media interface application 54 can utilize a default ABR value or setting in selecting bit rate of the video stream. The default ABR value may be specified in a master playlist accessed by the client device 24, with the default rate pre-defined in some manner. For example, the default ABR value may be the bit rate of a variant playlist that is first listed or “on top” of a set in the master playlist. In other embodiments, the default ABR value utilized to initiate streaming may be selected as the lowest or highest quality stream available, with the client device 24 actively varying stream quality during the ensuing media streaming session as appropriate. The bitrate of the video stream can be optimized by the streaming controller under current streaming environment, user preference, as monitored on a real-time or near real-time basis.

In some embodiments, the streaming media interface application 54 may further include a status message generation module 70 configured to periodically generate status messages (also known as heartbeat messages) indicating a current operating status of the client device and the playback of the streams. The status messages contain information about various operating parameters, including network connectivity, buffering status, playback rate, CPU and memory usage, and any errors encountered. The client device 24 may transmit the status messages to the streaming controller 23 in real time to allow the streaming controller 23 to analyze the statues messages, extract information from the status messages, and obtain operating status data related to the client device 24.

To establish a streaming video session, media server 22 receives an initial transmission from client device 24 via the communications network 26. This initial transmission may include data identifying the content desirably streamed to client device 24 and other information, such as data supporting authentication of the media server 22 and client device 24. Additionally, in embodiments where media server 22 assumes the form of a consumer placeshifting device, such as an STB or DVR located in the residence of an end-user, control commands or signals 62 may include instructions to remotely operate the placeshifting device, as appropriate. A streaming video session then ensues until termination by the media server 22 or client device 24.

FIG. 2 is a schematic diagram illustrating another example of a media streaming system 200 particularly for ABR video streaming. The system 200 is a variation of the system 100 of FIG. 1 and may contain the same or similar components of the system 100. In the illustrated example, the system 200 includes encoder 102 (e.g., the media encoder device 36 of the media server 22 shown in FIG. 1 (i.e., ABR media server)), content source(s) 32, router 110, client device, display device 28, audio device 90, storage device 117, remote-control device 120, connection server 130, database 132, bitrate controller 150, and the communications network 26.

In the illustrated example of FIG. 1, the remote-control device 120 is controlled by a user and is wirelessly connected to the client media. The remote-control device 120 may generate a user input for a user-selected video stream and initially attempt to obtain the user-selected media stream directly from the content source 32. The remote-control device 120 also establishes a connection 141 with the client device 24 (e.g., an STB or other home device) that is associated with the same user as the remote-control device 120. This connection 141 may be facilitated by a connection server 130 operating as a service on network 125, as explained more fully below. After the connection 141 is established, then the client device 24 is able to communicate with the content source 32 and function as an intermediary for obtaining segments 106 of the adaptive stream from the content source 107 and for forwarding the obtained segments 106 to the client device 24.

The various components of system 200 may be deployed under the control of different entities. In some embodiments, encoder 102, content source 32, connection server 130, and the bitrate controller 150 are jointly operated by a content distributor such as a cable television operator, a direct broadcast satellite (DBS) service provider, broadcast network, or the like. Such a distributor would typically support multiple customers, each with their own client devices 24 and remote-control device 120. Other embodiments could separate the encoding, distributing, controlling, and operating functions between different parties. A television network or other content producer could provide already-encoded media streams, for example, which could be made available via a commercially-available CDN or other server while a distributor or other party maintains control of the system 200 via connection server 130.

In some embodiments, client device 24 includes (or at least communicates with) a storage device 117 such as a hard disk drive, memory, or the like. Storage device 117 may be used in implementing a personal video recorder (PVR), for example, that stores received programming for later viewing. Storage device 117 may also be used for caching media segments that may not have been requested by the remote-control device 120 in some embodiments, as described below.

The client device 24 generally operates on a home network 119, such as a local area network (LAN) behind a router 110 or similar device. Typically, router 110 provides a firewall that blocks undesired traffic from the communications network 26 while allowing outgoing traffic from home network 119. Home network 119 may also include local media players or other client devices such as display device 28 and audio device 90 for receiving and presenting the content of the adaptive media streams, as desired.

Adaptive media streams may be created and distributed in any manner. As shown in FIG. 2, encoder 102 is any device or service capable of encoding media programs 104 into one or more adaptive streams 105a-105c. Encoder 102 may be, for example, a digital computer system that is programmed to create multiple streams 105a-105c each representing a media program 104 in its entirety, but with different bitrates, frame rates, resolution and/or other levels of quality. Typically, each stream 1051-105c is made up of smaller segments 106 that each represent a small portion of the program content with a single data file. Each stream 1051-105c is typically encoded so that segments 106 of the different streams 1051-105c are interchangeable with each other, often using a common timing index. This allows a client media player to mix and match segments 106 from different streams 1051-105c to create a media stream that effectively adapts as streaming environment conditions change. Other embodiments could use different encoding structures or techniques, as desired.

The sets of segments 106 making up each media stream 105 are stored on a CDN or other content source 32 for distribution on the Internet or another the communications network 26. Typically, a media player application (e.g., the application 54 of FIG. 1) executing on the client device 24 contains intelligent logic to select appropriate segments 106 as needed to obtain and playback the media program 104. As noted above, segments 106 may be interchangeable between media streams 105 so that higher quality segments 106 may be seamlessly intermixed with lower quality segments 106 to reflect changing network or other conditions in delivery over network 125. In some embodiments, the media player 124 initially obtains a digest or other description of the available segments 106 so that the player itself can select and request the particular segments 106 that are desired. Since the segments 106 are typically stored as separate files, segment requests may take the form of conventional hypertext transport protocol (HTTP) constructs (e.g., HTTP “get” instructions) or the like. Such constructs are readily routable on the communications network 26 and can be served by conventional CDN or other web-type servers no, and may provide a convenient mechanism for distributing adaptive media streams to the client device on the communications network 26.

In various embodiments, a connection server 130 is provided to locate the user's client device 24 on the communications network 26. To that end, connection server 130 is a computerized service that facilitates connection 141 among the client device 24, the remote-control device 120, and the content source 32. In many embodiments, connection server 130 executes on a conventional server or other digital computer that includes a processor, memory, input/output interfaces (e.g., an interface to the communications network 26), and/or the like. Equivalent embodiments could implement some or all of connection server 130 using cloud-based computing resources or the like.

Connection server 130 typically operates in conjunction with a database 132 that associates customers or other users with their particular client devices 24, and that maintains a current network address that can be used to contact the client device 24. Database 132 may additionally or alternately contain other information, such as information about the type, location or address of the client device 24, as desired.

With continued reference to FIG. 2, the bitrate controller 150 is an example of the streaming controller 23 of FIG. 1. In some embodiments, the bitrate controller 150 is integrated to the ABR media server. Alternatively, the bitrate controller 150 may be integrated as a component of the control logics 57 of the client device 24 shown in FIG. 1. The bitrate controller 150 includes, among other components, a network monitoring component 151, a client device tracker 152, an analysis component or analyzer 153, an output component 154, an artificial intelligence (AI) or machine leaning (ML) (AI/ML) component 155, a feedback component 156, and a database 157. “Component” used herein refers to a physical hardware component, a software component, or a combination of both, such as a server, a device, an engine, a module, or any tangible or intangible entity or a combination of both that can serve a particular purpose or perform a particular function.

The network monitoring component 151 may further include various monitoring tools responsible for collecting real-time network performance metrics data. Examples of the monitoring tools include but are not limited to Ping, traceroute, NetFlow analyzer, SNMP (simple network management protocol) monitoring, packet sniffer, bandwidth monitoring tool, Quality of Service (QOS) analyzer, application performance monitoring (APM) tool, Wi-Fi analyzer. For example, Ping may be used to test the reachability of the client device 24 on the communications network 26 and measures the round-trip time (RTT) for packets sent from the media server 22 to the client device 24 to obtain network latency data and packet loss data. Traceroute may be used to trace the route taken by packets across the communications network 26 or the CDN and identifies the network hops between the media server 22 and the client device 24. NetFlow analyzer may be used to monitor and analyze network traffic flows in real-time and provide visibility into network bandwidth usage, application performance, and security threats by analyzing flow data generated by the network devices (e.g., router 110, switches (not shown), and connection server 130, etc.) connected to the communications network 26. SNMP may be used to collect and analyze performance data from network devices, monitor current health status of each device, traffic utilization, and other metrics. Bandwidth monitoring tools may be used to track network bandwidth usage in real-time, monitor traffic patterns, identify bandwidth-intensive applications, and detect abnormal usage patterns that may indicate network congestion or security threats. QoS analyzer may be used to assess network performance based on predetermined service level agreements (SLAs) or QoS parameters and determine if the real-time network performance is in compliance with QoS standards. APM tool may be used to collect data including metrics such as response time, throughput, error rates, CPU and memory utilization, database query performance, latency, and more, during execution of the media player application on the client device 24.

As mentioned above, the network monitoring component 151 may be configured to generate real-time network performance data based on the data collected from various monitoring tools included therein. The real-time network performance data may include bandwidth availability, latency, packet loss, jitter, round-trip time (RTT), throughput, error rate, frame rate, and network protocol metrics. The bandwidth availability refers to the amount of available bandwidth on the network connection, which can be measured in bits per second (bps), kilobits per second (kbps), or megabits per second (Mbps). Latency refers to the time it takes for data packets to travel from the media server 22 to the client device 24 and back, typically measured in milliseconds (ms). Packet loss refers to the percentage of data packets lost or dropped during transmission via the network connection, which is an indicator network congestion or instability. Jitter refers to variability in the delay of packet delivery and fluctuations in packet arrival times. RTT refers to the total time it takes for a data packet to travel from the media server 22 to the client device 24 and back again and provides a holistic measure of the responsiveness of the communications network 26. Throughput refers to the rate at which data is transmitted over the network connection, typically measured in bps. Additional network protocol metrices may include metrics specific to the network protocol used, such as TCP (Transmission Control Protocol) or UDP (User Datagram Protocol), including retransmission rates, connection establishment times, and protocol-specific error indicators.

The client device tracker 152 is responsible for monitoring the operating status of the client device 24 and obtain real-time operating status data. For example, the client device tracker 152 may be configured to continuously monitor the operating status of client devices participating in streaming sessions, track various parameters such as device connectivity, performance metrics, playback status, and any error conditions that may arise during streaming. In some embodiments, the status message generation module 70 of the client device 24 is configured to periodically transmit status messages (e.g., at a time interview such as once per second) to indicate a current operating status of the client device 24. As mentioned above, the status messages contain information about various operating parameters, including network connectivity, buffering status, playback rate, CPU and memory usage, and any errors encountered. Upon receiving status messages from client device 24, the client device tracker 152 extracts relevant information using algorithms designed to parse and interpret the contents of the messages, identifies key operating parameters and extracts data points such as device performance metrics, playback rate, and other playback quality indicators. Based on the information extracted from the status messages, the client device tracker 152 generates operating status data in a structured format. The operating status data provides insights into the real-time operating conditions of client devices participating in streaming sessions and may be used by the bitrate controller 150 to make decisions about bitrate adjustments, resource allocation, and streaming optimization.

As mentioned above, the client device tracker 152 may be configured to generate real-time operating status data indicating a current operating status of the client device 24. The real-time operating status data may include device connectivity status data such as network connectivity status, signal strength, and IP addresses, streaming performance metrics data such as received bitrate, buffering status, playback rate, playback position, and playback latency, device performance metrics data like CPU and memory utilization, and video/audio quality metrics data including resolution, frame rate, and codec efficiency.

The analyzer 153 may collect real-time network condition data and device operating status data from the network monitoring component 151 and the client device tracker 152, respectively. As mentioned above, the data includes metrics such as network bandwidth, latency, packet loss, device CPU utilization, playback latency, and video/audio quality metrics. The analyzer 153 further aggregates and correlates the collected data to gain insights into the streaming environment. The analyzer 153 may employ one or more AI/ML models containing bitrate optimization algorithm(s) for bitrate optimization, based on the collected data. The AL/ML models may be used to estimate the available bandwidth of the network connection based on measurements such as throughput and packet loss rate, evaluate the capabilities of the client device 24, including its processing power, memory, and display resolution, analyze the characteristics of the streamed content, such as resolution, frame rate, and encoding complexity, incorporate various Quality of Experience (QoE) metrics, such as buffering events, playback interruptions, and user engagement, perform rate-distortion optimization to find the optimal balance between video quality and bitrate and maximize visual quality while minimizing the bitrate required for streaming. Based on the above, the analyzer 153 may dynamically select the optimal bitrate for the client device 24 and send control signals to the media server 22 to adjust the bitrate in real-time to adapt to changing network conditions and device capabilities.

As one example, the analyzer 153 may employ an AI/ML model containing a bitrate optimization algorithm for bitrate optimization based on network bandwidth and playback rate of the client device 24. The network monitoring component 151 may continuously monitor the available network bandwidth using techniques such as throughput estimation, packet loss analysis, or bandwidth probing. The client device tracker 152 measures the playback rate of the client device 24, which represents the rate at which the media player consumes data to render the content, and calculate the playback rate by tracking the time taken to render a certain amount of content (e.g., frames or audio samples) over a given time interval. The analyzer 153 may estimate the effective bandwidth available for streaming based on the measured network bandwidth and the desired playback rate and determine the maximum sustainable bitrate that can be supported by the available bandwidth without causing buffering or playback interruptions. If the available bandwidth exceeds the playback rate, the analyzer 153 may indicate a need to allocate a portion of the bandwidth for streaming and reserve the remaining bandwidth for other network activities. If the available bandwidth is lower than the playback rate, the analyzer 153 may indicate a need to adjust the streaming bitrate to match the available bandwidth while maintaining a smooth playback experience.

The output component 154 is configured to generate an output indicating a real-time optimal bitrate determined by the analyzer 153 and including an instruction/command to cause the media server to adjust the bitrate to the optimal bitrate. The bitrate controller 150 may transmit the output to the media server 22, such that the media server 22 may adjust the bitrate according to the instruction. Operating in a conjunctive manner, the bitrate controller 150 continuously monitor changes in network bandwidth and playback rate to detect variations in the streaming environment, the media server 22 adjusts the streaming bitrate dynamically in real time based on the available bandwidth and playback such that the bitrate remains optimized for the current network conditions, and increase or decrease the streaming bitrate as needed to adapt to fluctuations in network bandwidth while maintaining a consistent playback rate and minimizing buffering and freeze on the client device 24.

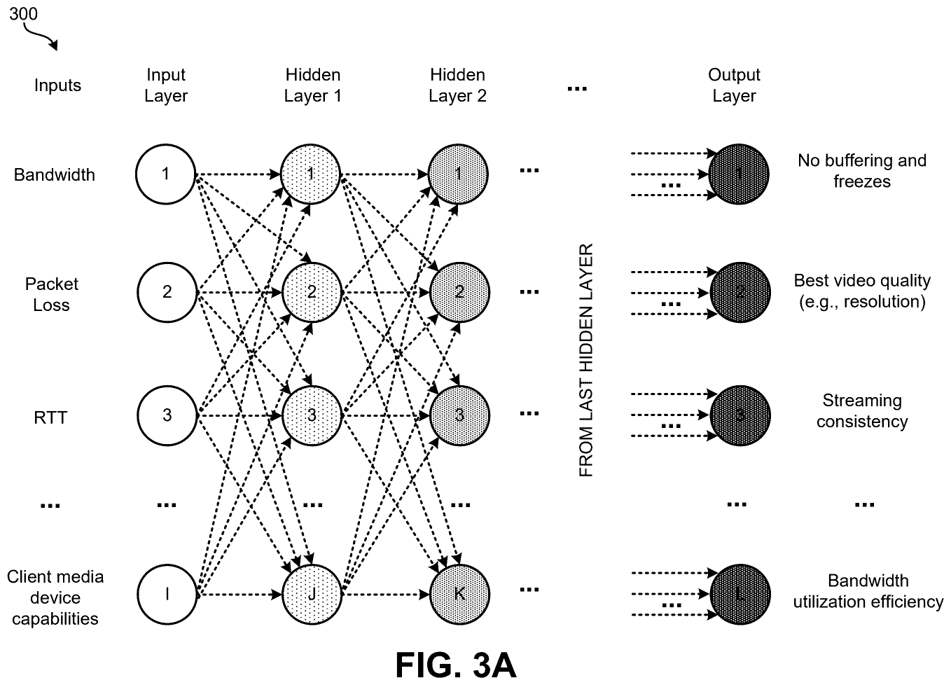

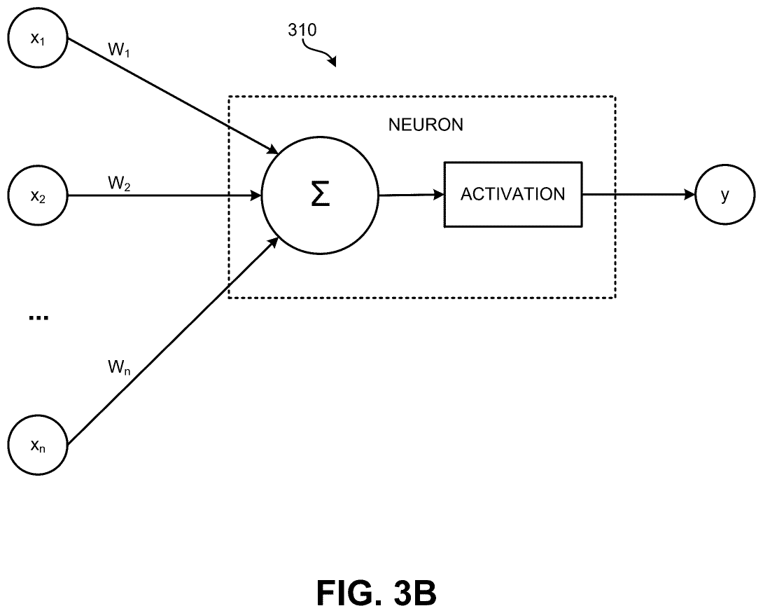

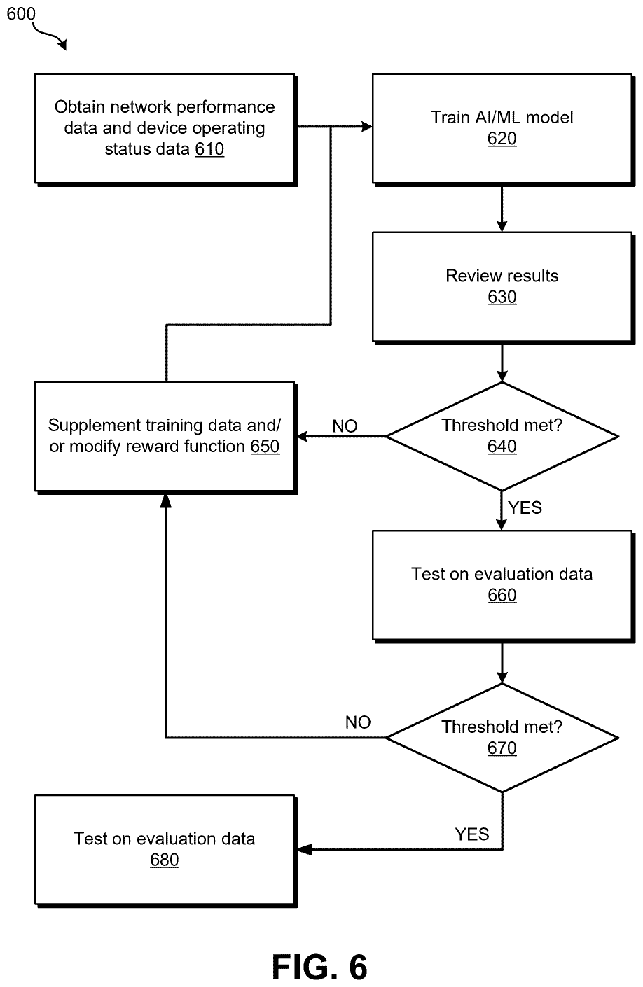

The AI/ML module 155 is configured to establish, develop, train, validate, and update one or more AI/ML models used by the analyzer 153 or other components within the bitrate controller 150 for bitrate optimization. In some embodiments, the AI/ML module 155 may generate one or more generative adversarial network (GAN) or a similar generative AI model using historical network performance data and the device operating status data. However, various other types of AI/ML models may be trained and deployed without deviating from the scope of the present disclosure. More examples of the AI/ML model are described below with reference to FIGS. 3A-3B and FIG. 6.

The feedback component 156 is configured to collect user preferences and quality of experience metrics, use collected feedback to fine-tune the AI/ML model and improve its accuracy, and continuously update the AI/ML model based on new data and user interactions to ensure optimal performance. The database 157 is configured to store and manage various data and information including the data generated and collected by the bitrate controller 23, AI/ML models, as well as user profiles (e.g., client device information, user identity and account, historical user behavior data, etc.).

FIG. 3A illustrates an example of a neural network 300 that has been trained to optimize bitrate or recommend an optimal bitrate for ABR streaming, according to various embodiment of the present disclosure. The neural network 300 may be a GAN and include a number of hidden layers. Both deep learning neural networks (DLNNs) and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 300.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers. For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

As illustrated in FIG. 3A, various parameters such as bandwidth, packet loss, latency, RTT, frame rate, CPU usage, memory capacity, etc., provided as the input layer are fed as inputs to the J neurons of hidden layer 1. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks (GANs), liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. It should be noted that numbers of neurons I, J, K, and L are not necessarily equal, and thus, any desired number of layers may be used for a given layer of neural network 300 without deviating from the scope of the present disclosure. Indeed, in certain embodiments, the types of neurons in a given layer may not all be the same.

It should be noted that neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative co and positive co, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 310 is shown in FIG. 3B. Inputs X₁, X₂, . . . , Xₙ, from a preceding layer are assigned respective weights W₁, W₂, . . . , Wₙ. Thus, the collective input from preceding neuron 1 is WᵢXᵢ. These weighted inputs are used for the neuron's summation function modified by a bias, such as:

$${\sum }_{i = 1}^{m} ( {W}_{i} {X}_{i} ) + bias \qquad ( 1 )$$

This summation is compared against an activation function f(x) to determine whether the neuron “fires”. For instance, f(x) may be given by

$$f ( X ) = \{ \begin{matrix}1 if {\sum }_{i = 1}^{m} ( {W}_{i} {X}_{i} ) + bias \geq 0 \\ 0 if {\sum }_{i = 1}^{m} ( {W}_{i} {X}_{i} ) + bias < 0\end{matrix} \qquad ( 2 )$$

The output y of neuron 310 may thus be given by:

$$y = f ( X ) {\sum }_{i = 1}^{m} ( {W}_{i} {X}_{i} ) + bias \qquad ( 3 )$$

In this case, neuron 310 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the present disclosure.

The goal, or “reward function” is often employed, such as for this case no buffering or freezes of the video streaming at the optimal bitrate and/or with maximum video quality allowed under the optimal bitrate. A reward function explores intermediate transitions and steps with both short-term and long-term rewards to guide the search of a state space and attempt to achieve a goal (e.g., determining when the network is likely to be congested, identifying the optimal bitrate, etc.).

During training, various labeled data (e.g., network performance data and device operating status data) is fed through neural network 300. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, the reward function may be modified to provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions fᵢ between each layer i=1, . . . , N of the network, with the output at a given layer first multiplied by a synaptic matrix Wi, and with a bias vector bi added. The network output o, given by:

$$o = {f}_{N} ( {W}_{N} {f}_{N - 1} ( {W}_{N - 1} {f}_{N - 2} ( … {f}_{1} ( {W}_{1} X + {b}_{1} ) … ) + {b}_{N - 1} ) + {b}_{N} ) \qquad ( 4 )$$

In some embodiments, o is compared with a target output t, resulting in an error (E), which is expressed below and desired to be minimized:

$$E = \frac{1}{2} {‖ o - t ‖}^{2} \qquad ( 5 )$$

Optimization in the form of a gradient descent procedure may be used to minimize the error by modifying the synaptic weights Wᵢ for each layer. The gradient descent procedure requires the computation of the output o given an input x corresponding to a known target output t, and producing an error (o-t). This global error is then propagated backwards giving local errors for weight updates with computations similar to, but not exactly the same as, those used for forward propagation. In particular, the backpropagation step typically requires an activity function of the form pⱼ(nⱼ)=fⱼ′(nⱼ), where nⱼ is the network activity at layer j (i.e., nⱼ=Wⱼoⱼ₋₁+bⱼ) where oⱼ=fⱼ(nⱼ) and the apostrophe ' denotes the derivative of the activity function f.

The weight updates may be computed via the formulae:

$${d}_{j} = \{ \begin{matrix}( o - t ) ∘ {p}_{j} ( {n}_{j} ) , & j = N \\ {W}_{j = 1}^{T} {d}_{j + 1} ∘ {p}_{j} & j < N\end{matrix} \qquad ( 6 )$$

$$\frac{\partial E}{\partial {W}_{j + 1}} = {{d}_{j + 1} ( {o}_{j} )}^{T} \qquad ( 7 )$$

$$\frac{\partial E}{\partial {b}_{j + 1}} = {d}_{j + 1} \qquad ( 8 )$$

$${W}_{j}^{new} = {W}_{j}^{old} - η \frac{\partial E}{\partial {W}_{j}} \qquad ( 9 )$$

$${b}_{j}^{new} = {b}_{j}^{old} - η \frac{\partial E}{\partial {b}_{j}} \qquad ( 10 )$$

where ∘ denotes a Hadamard product (i.e., the element-wise product of two vectors), T denotes the matrix transpose, and oⱼ denotes fⱼ(Wⱼoⱼ₋₁+bⱼ), with o₀=X. Here, the learning rate η is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data, but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. This may collectively allow the AI/ML models to enable semantic understanding to better predict event-based congestion or service interruptions due to an accident, for instance.

In some embodiments, transformer networks may be used. Examples of the transformer network includes SentenceTransformers™, which is a Python™ framework for state-of-the-art sentence, text, and image embeddings. Such transformer networks learn associations of words and phrases that have both high scores and low scores. This trains the AI/ML model to determine what is close to the input and what is not, respectively. Rather than just using pairs of words/phrases, transformer networks may use the field length and field type, as well.

Natural language processing (NLP) techniques such as word2vec, BERT, GPT-3.5, etc. may be used in some embodiments to facilitate semantic understanding. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DB SCAN clustering algorithm, the Gaussian mixture model (GMM) algorithms, the balance iterative reducing and clustering using hierarchies (BIRCH) algorithm, etc. Such techniques may also assist with categorization.

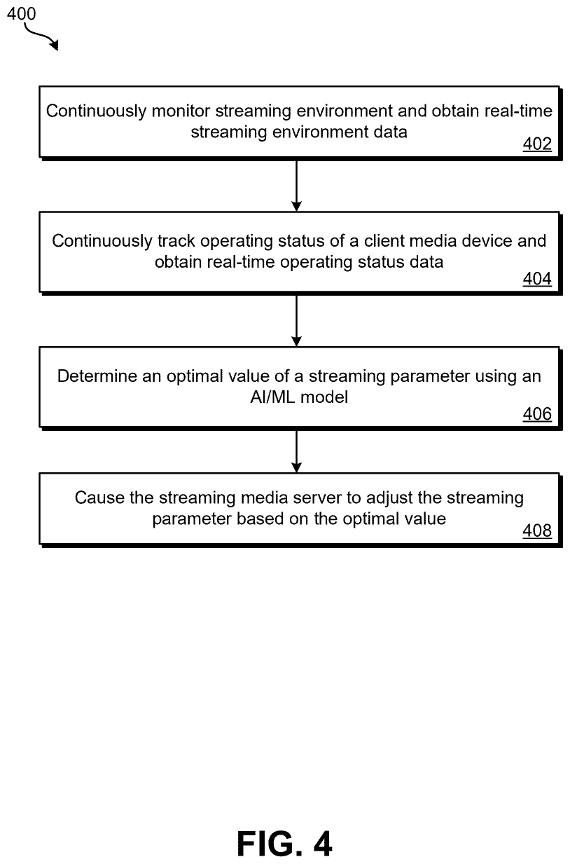

FIG. 4 is a flow diagram illustrating an example method 400 for dynamically and responsively control streaming parameters, according to various embodiments of the present disclosure. Method 400 may be performed by the media streaming systems 100 or 200, or any component thereof, such as the streaming controller 23. In the illustrated example, method 400 may include operations/steps 402-408. Few or additional operations/steps may be included. The operations of method 400 may be combined with operations of another method described herein in any suitable manner.

At 402, streaming environment for a client device connected to a network is continuously monitored by a streaming controller. In some embodiments, the streaming controller is a centralized server independent from the client device. Real-time streaming environment data is obtained by the streaming controller. The real-time streaming environment data indicate a current condition of the streaming environment at each individual time period along a chronological timeline. In some embodiments, the streaming environment data includes network performance data such as available network bandwidth of the network. In some embodiments, the streaming environment data further indicates network latency, RTT, packet loss, etc. In some embodiments, the streaming environment data for each time period is an average of the data points obtained for that time period.

At 404, operating status of the client device is continuously tracked by the streaming controller, and real-time operating status data is obtained by the streaming controller. The real-time operating status data indicate a current operating status of the client device at each individual time period along the chronological timeline. In some embodiments, timestamped status messages are periodically generated by the client device, transmitted to, and received by the streaming controller. The timestamp of each status message may correspond to a time point (e.g., a starting time point, or a middle time point) of each time period. The status messages contain information about capacity of the client device and a current operating status of the client device at each individual time period respectively corresponding to each one of the status messages. The information is extracted by the streaming controller to generate the operating status data. In some embodiments, the operating status data includes a current playback status of the stream such as the presence or absence of buffering or freeze, frame rate, resolution, etc. In some embodiments, the current playback status also indicates CPU/processing power, available memory, codec efficiency, etc. In some embodiments, the operating status data for each time period is an average of the data points obtained for that time period.

At 406, an optimal value of one or more streaming parameter for each time period along the chronological timeline is determined by the streaming controller, based on the streaming environment data and the operating status data using an AI/ML model. The AI/ML model may be developed by the streaming controller using historical streaming environment data and the operating status data and continuously updated with the newly obtained streaming environment data and operating status data. In some embodiments, a current condition of the streaming environment and a current operating status of the client device corresponding to a current time period are used by the streaming controller to determine the optimal values of the streaming parameter for the subsequent time period along the chronological timeline. In some embodiments, the streaming parameter is the bitrate, and the optimal value is the optimal bitrate.

At 408, the media server is caused by the streaming controller to adjust the streaming parameters based on the optimal value. In some embodiments, control signals indicating a command to change/adjust the values of the streaming parameter to an optimal value for each one of the time periods are generated by the media server and transmitted to the media server. The values or the streaming parameters are changed to the optimal values accordingly by the media server. In some embodiments, the streaming parameters include bitrate for each time period. In some embodiments, the streaming parameters further include optimal resolution corresponding to each time period, optimal codec corresponding to each time period, encoding setting corresponding to each time period, optimal buffer/pre-fetching size corresponding to each time period, etc.

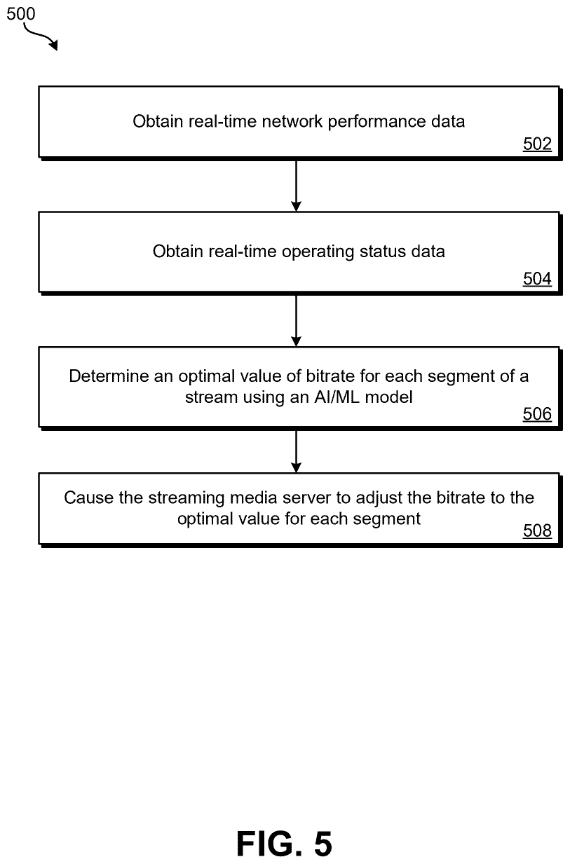

FIG. 5 is a flow diagram illustrating another example method 500 for dynamically and responsively control bitrate for ABR streaming, according to various embodiments of the present disclosure. Method 500 may be performed by the media streaming systems 100 or 200, or any component thereof, such as the media server 22, streaming controller 23, and the client device 24, etc. In the illustrated example, method 500 may include operations/steps 502-508. Few or additional operations/steps may be included. The operations of method 500 may be combined with operations of another method described herein in any suitable manner.e

At 502, network condition of a network in connection with a media server, a client device, and a bitrate controller is continuously monitored by the bitrate controller. As a media stream is transmitted from the media server to the client device, it is segmented into discrete units (i.e., segments) corresponding to specific time periods along a chronological timeline. The time periods can range from 1 second to 10 seconds, although other durations are also possible within the scope of the disclosure. During the streaming process, the real-time network performance data pertaining to the network connection between the media server and the client device is continuously obtained by the bitrate controller. The network performance data includes information such as the current network bandwidth available to the client device for each individual segment of the media stream. Other data such as network latency, RTT, packet loss, etc., may also be obtained. In some embodiments, the network performance data for each time period is an average of the data points obtained for that time period.

At 504, operating status of the client device is continuously tracked by the bitrate controller, and real-time operating status data is obtained by the bitrate controller. The real-time operating status data indicate a current operating status of the client device at each individual time period corresponding to each segment of the media stream. In some embodiments, status messages are periodically generated by the client device, transmitted to, and received by the streaming controller. The status messages are timestamped and respectively correspond to the sequential time periods along the chronological timeline. Each status message contains information about capacity of the client device and a current operating status of the client device corresponding to each one of the segments of the media stream. The information is extracted by the streaming controller to generate the operating status data. In some embodiments, the operating status data includes a current playback status of the stream such as the presence or absence of buffering or freeze, frame rate, resolution, etc. In some embodiments, the current playback status also indicates CPU/processing power, available memory, codec efficiency, etc. In some embodiments, the operating status data for each time period is an average of the data points obtained for that time period.

At 506, an optimal bitrate for each one of the sequential segments of the media stream is determined by the streaming controller during streaming, based on the network performance data and the operating status data using an AI/ML model. The AI/ML model may be developed by the streaming controller using historical network performance data and the operating status data and continuously updated with the newly obtained network performance data and operating status data. In some embodiments, a current network condition of the network and a current operating status of the client device corresponding to a current segment are used by the streaming controller to determine the optimal bitrate for the subsequent segment.

At 508, the media server is caused by the streaming controller to adjust the bitrate to the optimal value. In some embodiments, control signals indicating a command to change/adjust the bitrate to the optimal value for each one of the time periods are generated by the media server and transmitted to the media server. The bitrate for the subsequent segment is adjusted to the optimal value accordingly by the media server. In some embodiments, other streaming parameters for the subsequent segment such as encoding parameters (e.g., resolution, codec, frame rate, audio quality, etc.), buffer/pre-fetching size, etc., are also adjusted respectively to their corresponding optimal values.

FIG. 6 is a flow diagram illustrating an example process 600 for training AI/ML model(s) specific to a client device, according to an embodiment of the present disclosure. The process 600 begins with providing training data, such as historical streaming environment data, historical network performance data, and historical device operating status data, etc. at 610, whether labeled or unlabeled. The historical data pertains to the specific client device. Other training data used in addition to or in lieu of the training data shown in FIG. 6 may include, but is not limited to, historical bandwidth availability, historical network latency, historical packet loss, historical jitter, historical RTT, historical throughput, historical error rate, historical frame rate, historical network protocol metrics, historical network connectivity of client device, historical device buffering, historical device playback rate, historical device CPU and memory usage, historical errors, etc. Indeed, the nature of the training data that is provided will depend on the objective that the AI/ML model is intended to achieve. The AI/ML model is then trained over multiple epochs at 620 and results are reviewed at 630.

If the AI/ML model fails to meet a desired confidence threshold at 640, the training data is supplemented and/or the reward function is modified to help the AI/ML model achieve its objectives better at 650 and the process returns to step 620. If the AI/ML model meets the confidence threshold at 640, the AI/ML model is tested on evaluation data at 660 to ensure that the AI/ML model generalizes well and that the AI/ML model is not over fit with respect to the training data. The evaluation data includes information that the AI/ML model has not processed before. If the confidence threshold is met at 670 for the evaluation data, the AI/ML model is deployed at 680. If not, the process returns to step 650 and the AI/ML model is trained further.

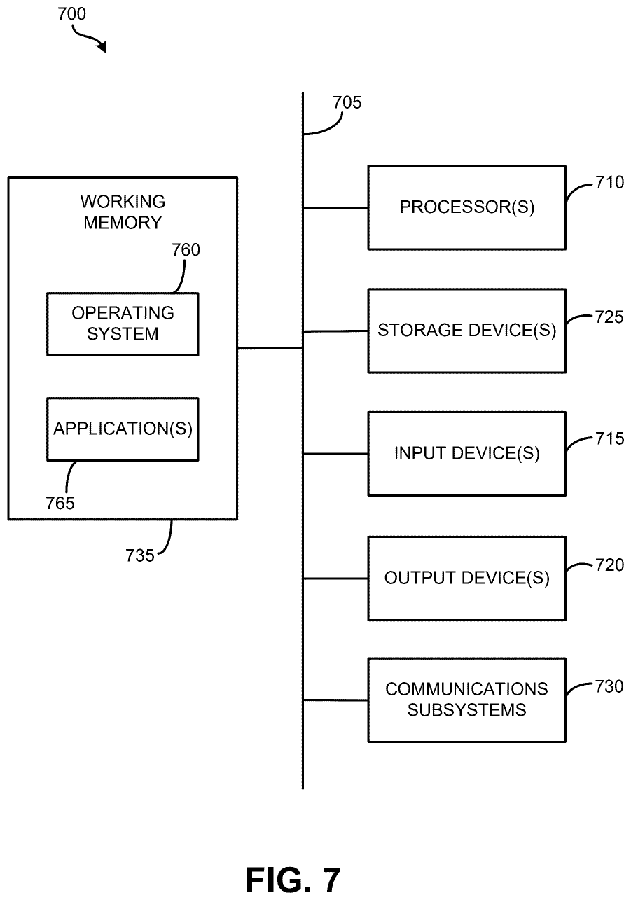

The media streaming systems 100 and 200 or any components thereof, such as the media server 22, streaming controller 23, and client device 24, etc., described above may include a computer system that further includes computer hardware and software that form special-purpose network circuitry to implement various embodiments such as communication, generation of data, generation of AI/ML models, detection, analysis, determination, identification, calculation, execution of a process, and other operations or steps of the methods or processes described herein. FIG. 7 is a schematic diagram illustrating an example of computer system 700. The computer system 700 is a simplified computer system that can be used to implement various embodiments described and illustrated herein. FIG. 7 provides a schematic illustration of one embodiment of a computer system 700 that can perform some or all of the steps of the methods and workflows provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner. The computer system 700 is shown including hardware elements that can be electrically coupled via a bus 705, or may otherwise be in communication, as appropriate. The hardware elements may include one or more processors 710, including without limitation one or more general-purpose processors and/or one or more special-purpose processors such as digital signal processing chips, graphics acceleration processors, and/or the like; one or more input devices 715, which can include without limitation a mouse, a keyboard, a camera, and/or the like; and one or more output devices 720, which can include without limitation a display device, a printer, and/or the like.

The computer system 700 may further include and/or be in communication with one or more non-transitory storage devices 725, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset such as a Bluetooth™ device, a 802.11 device, a WiFi device, a WiMax device, cellular communication facilities, etc., and/or the like. The communications subsystem 730 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 730. In other embodiments, a portable electronic device, e.g., the first electronic device, may be incorporated into the computer system 700, e.g., an electronic device as an input device 715. In some embodiments, the computer system 700 will further include a working memory 735, which can include a RAM or ROM device, as described above.

The computer system 700 also can include software elements, shown as being currently located within the working memory 735, including an operating system 760, device drivers, executable libraries, and/or other code, such as one or more application programs 765, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 7, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 725 described above. In some cases, the storage medium might be incorporated within a computer system, such as computer system 700. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 700 to perform methods in accordance with various embodiments of the technology. According to a set of embodiments, some or all of the operations of such methods are performed by the computer system 700 in response to processor 710 executing one or more sequences of one or more instructions, which might be incorporated into the operating system 760 and/or other code, such as an application program 765, contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 and/or components thereof generally will receive signals, and the bus 705 then might carry the signals and/or the data, instructions, etc. carried by the signals to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a segment” includes a plurality of such segments, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

As used herein, “media content,” “media program,” “multimedia content,” “content,” or variants thereof should be understood as referring to any audiovisual programming or content in any streaming, file-based, or another format. The media content generally includes data that, when processed by a media player or decoder, allows the media player or decoder to present a visual and/or audio representation of the corresponding program content to a viewer (i.e., the user of a client device including the media player or decoder). In one or more embodiments, a media player can be realized as a piece of software that plays multimedia content (e.g., displays video and plays audio).

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A media streaming system comprising:
a media server connected to a network; and
a bitrate controller connected to the network,
wherein the media server is configured to transmit a media stream to a client device connected to the network in a sequence of successive time periods along a chronological timeline,
wherein the bitrate controller is configured to:
continuously monitor the network and obtain real-time network performance data indicating a current status of the network for each time period;
obtain real-time operating status data indicating a current operating status of the client device for each time period;
apply a machine learning (ML) model to determine a bitrate for each time period, the ML model being configured to optimize bitrate for each time period, based on the network performance data and the operating status data corresponding to each time period; and
cause the media server to transmit the media stream to the client device at the determined bitrate for each time period.

2. The system of claim 1, wherein the current status of the network indicates a current network bandwidth available to the client device.

3. The system of claim 2, wherein the current status of the network further indicates a current latency, a current round trip time (RTT), and a current packet loss rate pertaining to the network.

4. The system of claim 1, wherein the current operating status indicates a current playback status of the stream, and an available processing capacity and an available memory capacity of the client device.

5. The system of claim 1, wherein the bitrate controller is further configured to:
continuously receive a sequence of status messages periodically generated by and sent from the client device,
wherein the status messages are timestamped and respectively corresponding to the time periods, each one of the status messages indicates the current operating status of the client device for the corresponding time period.

6. The system of claim 1, wherein the media server is further configured to:
divide the media stream into a sequence of segments corresponding to the sequence of the time periods,
wherein each one of the segments is transmitted to the client device at the determined bitrate for the corresponding segment.

7. The system of claim 6, wherein the bitrate for a selected one of the segments is determined based on the current status of the network and the current operating status of the client device corresponding to the segment preceding the selected segment.

8. The system of claim 6, wherein the media server is further configured to:
encode each one of the segments based on the determined bitrate for the segment,
wherein each encoded segment is transmitted to the client device at the determined bitrate.

9. The system of claim 1, wherein the bitrate controller is further configured to:
train the machine learning (ML) on a generative adversarial network (GAN) using historical network performance data and operating status data specific to the client device as training data.

10. The system of claim 6, wherein the bitrate controller is further configured to:
generate commands to transmit each one of the segments to the client device at the determined bitrate for the corresponding segment; and
transmit the commands to the media server.

11. A bitrate controller device connected to a media server configured to transmit a media stream to a client device via a network in a sequence of successive time periods along a chronological timeline, the bitrate controller device comprising:
one or more processors; and
a computer-readable storage media storing computer-executable instructions, wherein the instructions, when executed by the one or more processors, cause the bitrate controller device to:
continuously monitor the network connected to the client device and obtain real-time network performance data indicating a current status of the network for each time period;
obtain real-time operating status data indicating a current operating status of the client device for each time period;
apply a machine learning (ML) model to determine a bitrate for each time period, the ML model being configured to optimize bitrate for each time period, based on the network performance data and the operating status data corresponding to each time period; and
cause the media server to transmit the media stream to the client device at the determined bitrate for each time period.

12. The bitrate controller device of claim 11, wherein the current status of the network indicates a current network bandwidth available to the client device, and the current operating status indicates a current playback status of the stream, and an available processing capacity and an available memory capacity of the client device.

13. The bitrate controller device of claim 11, wherein the instructions when executed by the one or more processors further cause the bitrate controller device to:
continuously receive a sequence of status messages periodically generated by and sent from the client device,
wherein the status messages are timestamped and respectively corresponding to the time periods, each one of the status messages indicates the current operating status of the client device for the corresponding time period.

14. The bitrate controller device of claim 11, wherein the media server is configured to divide the media stream into a sequence of segments corresponding to the sequence of the time periods, and each one of the segments is transmitted to the client device at the determined bitrate for the corresponding segment.

15. The bitrate controller device of claim 14, wherein the bitrate for a selected one of the segments is determined based on the current status of the network and the current operating status of the client device corresponding to the segment preceding the selected segment.

16. The bitrate controller device of claim 11, wherein the ML model is trained on a generative adversarial network (GAN) using historical network performance data and operating status data specific to the client device as training data.

17. A method for transmitting a media stream from a media server to a client device via a network in a sequence of successive time periods along a chronological timeline, the method comprising:
continuously monitoring the network by a bitrate controller connected to the network and obtaining real-time network performance data indicating a current status of the network for each time period;
obtaining, by the bitrate controller, real-time operating status data indicating a current operating status of the client device for each time period;
applying a machine learning (ML) model to determine a bitrate for each time period, the ML model being configured to optimize bitrate for each time period, based on the network performance data and the operating status data corresponding to each time period; and
transmitting, by the media server, the media stream to the client device at the determined bitrate for each time period.

18. The method of claim 17, wherein the current status of the network indicates a current network bandwidth available to the client device, and the current operating status indicates a current playback status of the stream, and an available processing capacity and an available memory capacity of the client device.

19. The method of claim 17, further comprising:
continuously receiving, in the bitrate controller, a sequence of status messages periodically generated by and sent from the client device,
wherein the status messages are timestamped and respectively corresponding to the time periods, each one of the status messages indicates the current operating status of the client device for the corresponding time period.

20. The method of claim 17, wherein the bitrate for each time period is determined using a ML model, and the ML model is trained on a generative adversarial network (GAN) using historical network performance data and operating status data specific to the client device as training data.
